(19) United States
(12) Patent Application Publication
(10) Pub. No.: US 2016/0192308 A1
(43) Pub. Date: Jun. 30, 2016

(54) Mobile Device Synchronization of Screen Content and Audio

(71) Applicants: Dylan Elliot Turney, London (GB); Nicholas Jonathan Redwood, London (GB)

(72) Inventors: Dylan Elliot Turney, London (GB); Nicholas Jonathan Redwood, London (GB)

(21) Appl. No.: 14/823,046

(22) Filed: Aug. 11, 2015

Related U.S. Application Data
(60) Provisional application No. 62/035,757, filed on Aug. 11, 2014.

(51) Int. Cl. H04W 56/00; H04W 4/02; H04L 12/26

(52) U.S. Cl. CPC H04W 56/0015; H04L 43/10; H04W 4/021

(57) ABSTRACT

Systems and methods for providing synchronized visible and/or audible content for play on a plurality of mobile devices. The disclosed systems and methods can provide, to each of the plurality of mobile devices, a piece of the visible and/or audible content that is mapped to a specific location of the mobile device within a particular venue, and trigger the respective mobile devices to play their pieces of the visible and/or audible content in a synchronous fashion, thereby creating a display of the visible and/or audible content in which each mobile device effectively corresponds to either a picture element (or “pixel”) or a sound source, or both, within the display.

### CROSS REFERENCE TO RELATED APPLICATIONS

This application claims benefit of the priority of U.S. Provisional Patent Application No. 62/035,757 filed Aug. 11, 2014 entitled MOBILE DEVICE SYNCHRONIZATION OF SCREEN CONTENT AND AUDIO.

### TECHNICAL FIELD

The present application relates generally to systems and methods of playing visible and/or audible content on a plurality of computerized devices, and more specifically to systems and methods of playing synchronized visible and/or audible content on a plurality of mobile devices located within a venue.

### BACKGROUND

Through the years, audience members attending musical performances and sporting events have sought to express their appreciation to performers and athletes alike in various ways. For example, in the late 1960's, the practice of holding up lighted matches and/or cigarette lighters in the air at rock concerts gained increased popularity. Typically, audience members attending such rock concerts would raise lighted matches and/or cigarette lighters in the air during the performance of particular musical selections while the concerts were in progress, and/or at the end of the concerts in order to signal their desire for an encore. During the 1980's, the wave (also known as the “Mexican wave”) became popular among audience members attending sporting events at stadiums and/or arenas that host soccer tournaments, football matches, baseball games, etc. In order to perform the wave at such sporting events, successive groups of audience members would rise from their seats, briefly stand, raise their arms, and cheer, and then return to their seated positions, thereby creating the appearance of a wave of cheering spectators propagating through the stadium or arena.

In later years, as the popularity of cigarette smoking decreased and the use of cell phones increased, many audience members attending rock and/or pop concerts began to use their cell phones in place of lighted matches and/or cigarette lighters to express their appreciation to musical performers, holding their cell phones aloft with displays activated much in the same way as audience members in earlier times raised their lighted matches and/or cigarette lighters in the air. Such practice generally continued as audience members gradually replaced their aging cell phones with newer smartphones and/or tablet computers (or “tablets”).

Some musical performers embraced the concept of smartphone and/or tablet use by audience members during their musical performances by integrating the use of such smartphones and/or tablets into their performances. One such musical performer has developed a mobile application program (or “mobile application”) that audience members can download and run on their smartphones and/or tablets, enabling a stage technician to send coded audio signals to the audience members' smartphones and/or tablets in order to control the outputs of their associated display screens, speakers, and/or light emitting diodes (LEDs). In this way, the stage technician can control the lighting and/or colors produced by the display screens and LEDs, and/or the sounds emitted by the speakers, in an effort to make the audience members' smartphones and/or tablets a part of a musical performance. Such a mobile application has drawbacks, however, due to the inherent limitations in controlling outputs of smartphones and/or tablets using coded audio signals, as well as the inability to target control over such outputs to certain ones of the smartphones and/or tablets located in various areas of a stadium or arena.

It would therefore be desirable to have systems and methods of playing visible and/or audible content on a plurality of mobile devices located within a venue that avoid at least some of the drawbacks of the conventional approaches discussed herein.

### SUMMARY

In accordance with the present application, systems and methods are disclosed for providing synchronized visible and/or audible content for play on a plurality of mobile devices located within a venue. The disclosed systems and methods can provide, to each of the plurality of mobile devices, a piece of the visible and/or audible content that is mapped to a specific location of the mobile device within the venue, and trigger the respective mobile devices to play their pieces of the visible and/or audible content in a synchronous fashion, thereby creating a display of the visible and/or audible content in which each mobile device effectively corresponds to either a picture element (or “pixel”) or a sound source, or both, within the display.

In one aspect, a system for providing synchronized visible and/or audible content for play on a plurality of mobile devices located within a venue includes the plurality of mobile devices, a computerized controller (or “controller”), and at least one remote server computer (or “remote server”), which is communicably coupleable to each of the plurality of mobile devices and the controller over at least one network. For example, each mobile device can be a smartphone, a tablet computer (or “tablet”), or any other suitable computerized mobile device. Further, the network can be the Internet and/or any other suitable wired and/or wireless communications network. Each mobile device includes a processor, a memory, an internal clock, a display screen, a speaker, and a content database. The processor within the mobile device is operative to execute a mobile application program (or “mobile application”) out of the mobile device's memory for implementing specified functionality of the mobile device within the system. The controller and the remote server each likewise include a processor, a memory, and an internal clock. The processor within the controller is operative to execute a controller application program (or “controller application”) out of the controller's memory for implementing specified functionality of the controller within the system. The remote server further includes a content database.

In one mode of operation, the system can be employed in a venue such as a concert hall, a sports stadium or arena, a playing field, or any other suitable venue that typically attracts a large number (e.g., hundreds, thousands) of audience members. Preferably, each (or at least a majority) of the audience members has a mobile device (e.g., a smartphone, a tablet) in his or her possession at the venue, and is situated with the mobile device at a specific location in an audience area of the venue. In an exemplary aspect, the audience area can be divided into a plurality of sub-areas, and the specific location of the mobile device within the venue can correspond to one of the plurality of sub-areas of the audience area. Further, each mobile device has a copy of the mobile application downloaded onto it. For example, each audience member may download a copy of the mobile application into the memory of his or her mobile device while at the venue, or prior to arriving at the venue. Having downloaded the copy of the mobile application onto his or her mobile device, each audience member can open the mobile application on the mobile device while at the venue, allowing the processor within the mobile device to execute the mobile application out of the mobile device's memory.

In a further exemplary aspect, the mobile application running on each mobile device can perform the following operations in order to prepare the mobile device for playing synchronized visible and/or audible content substantially in unison with the other mobile devices located within the venue. For example, the visible and/or audible content can correspond to a static or dynamic image (e.g., a sports team banner), a static or dynamic pattern (e.g., a sweeping wave pattern), a series of audio and/or light tracks, an array of hexadecimal color values, and/or any other suitable visible and/or audible content. First, the mobile application establishes, over the network, a secure connection between the mobile device and the remote server, enabling full duplex, real-time communications between the mobile device and the remote server over the secure connection through the network. Next, the mobile application communicates with the remote server over the secure connection to synchronize the internal clock of the mobile device with the internal clock of the remote server, producing a positive or negative offset value that the mobile application can add to a time value of the mobile device's internal clock in order to simulate the time of the remote server's internal clock. The mobile application running on each mobile device then subscribes to a specific channel of the remote server, allowing the remote server to publish, over the subscribed channel, one or more trigger messages to the respective mobile devices. For example, in response to one or more directives from the controller, the remote server can publish such a trigger message(s) over the subscribed channel to direct the mobile applications running on some or all of the respective mobile devices to play pieces of the visible and/or audible content in a synchronous fashion. The mobile application can then determine the specific location (e.g., latitude, longitude, section number, seat number) of the mobile device in the audience area of the venue (using global positioning system (GPS) technology, Bluetooth beacon technology, etc.), and send an indication of the determined location of the mobile device, along with an event identifier, to the remote server over the secure connection. Having sent the specific location of the mobile device to the remote server, the mobile application running on each mobile device can receive, at a selected time(s) from the remote server over the secure connection, a piece of the visible and/or audible content that is mapped to the sub-area of the audience area that corresponds to the specific location of the mobile device within the venue. Preferably, the mobile application receives the piece of the visible and/or audible content in its entirety, and stores the entire piece of visible and/or audible content in the mobile device's content database. Once the mobile applications running on the plurality of mobile devices have prepared the respective mobile devices for playing their stored pieces of the visible and/or audible content substantially in unison in the audience area of the venue, the mobile applications running on the respective mobile devices can wait to receive one or more trigger messages from the remote server over the subscribed channel.

With regard to this exemplary aspect, the processor within the controller can execute the controller application out of the memory of the controller to perform the following operations in order to prepare the controller to send one or more directives to the remote server. First, the controller application running on the controller establishes, over the network, a secure connection between the controller and the remote server, enabling full duplex, real-time communications between the controller and the remote server over the secure connection through the network. Next, the controller application can communicate with the remote server to synchronize the internal clock of the controller with the internal clock of the remote server, producing a positive or negative offset value that the controller application can add to a time value of the controller's internal clock in order to simulate the time of the remote server's internal clock. The controller application then sends, at a selected time(s) during a musical performance, a sporting event, or any other suitable performance or event being held at the venue, one or more directives to the remote server, causing the remote server to publish, over the subscribed channel, one or more trigger messages to the mobile applications running on the respective mobile devices within the venue. For example, such trigger messages can each contain a track identifier identifying the piece of visible and/or audible content stored on a respective mobile device, as well as a timestamp indicating a corresponding time within the stored piece of visible and/or audible content where the playing of the stored piece of content on the mobile device is to start. Having received the trigger message(s) from the remote server, the mobile applications running on the respective mobile devices play, in a synchronous fashion, the stored pieces of the visible and/or audible content on the display screens and/or the speakers of the respective mobile devices, thereby creating a display of the visible and/or audible content that can encompass substantially the whole audience area of the venue, in which each mobile device in the audience area effectively corresponds to either a pixel or a sound source, or both, within the display. The mobile application running on each mobile device achieves such synchronized playing of the stored pieces of the visible and/or audible content by adding the offset value obtained by the mobile application to the current time of the mobile device's internal clock in order to synchronize the mobile device's internal clock with the remote server's internal clock, and playing its stored piece of the visible and/or audible content starting at a time within the stored piece of content specified by a trigger message relative to the synchronized time of the mobile device's internal clock.

By (1) preparing visible and/or audible content to be played in a venue, (2) mapping pieces of the visible and/or audible content to a plurality of sub-areas of an audience area of the venue, (3) receiving the mapped pieces of the visible and/or audible content from a remote server and storing the mapped pieces of content within a plurality of mobile devices based on the mobile devices' specific locations within the venue that correspond to the plurality of sub-areas of the audience area, (4) synchronizing an internal clock of each mobile device with the remote server's internal clock, and (5) triggering the plurality of mobile devices to play their stored pieces of the visible and/or audible content in a synchronous fashion, starting at times within the stored pieces of content specified by a trigger message relative to the synchronized times of the mobile devices' internal clocks, a display of the visible and/or audible content can be created in the audience area of the venue, in which each mobile device can effectively correspond to a pixel, a sound source, or both, within the display. In this way, the attention, engagement, participation, and overall enjoyment of audience members attending a musical performance, a sporting event, or any other suitable performance and/or event being held at the venue can, advantageously, be enhanced.

Other features, functions, and aspects of the invention will be evident from the Detailed Description that follows.

### BRIEF DESCRIPTION OF THE DRAWINGS

The accompanying drawings, which are incorporated in and constitute a part of this specification, illustrate one or more embodiments described herein and, together with the Detailed Description, explain these embodiments. In the drawings:

FIG. 1a is a block diagram of an exemplary system for providing synchronized visible and/or audible content for play on a plurality of mobile devices located within a venue, in accordance with the present application;

FIG. 1b is a block diagram of an exemplary one of the plurality of mobile devices included in the system of FIG. 1a;

FIG. 1c is a block diagram of an exemplary controller included in the system of FIG. 1a;

FIG. 1d is a block diagram of an exemplary remote server included in the system of FIG. 1a;

FIG. 2 is a representation of an exemplary display of the visible and/or audible content played on the plurality of mobile devices included in the system of FIG. 1a;

FIG. 3 is a flow diagram of an exemplary method of synchronizing an internal clock of the exemplary mobile device of FIG. 1b with an internal clock of the exemplary remote server of FIG. 1d; and

FIG. 4 is a flow diagram of an exemplary method of providing synchronized visible and/or audible content for play on the plurality of mobile devices included in the system of FIG. 1a.

### DETAILED DESCRIPTION

The disclosure of U.S. Provisional Patent Application No. 62/035,757 filed Aug. 11, 2014 entitled MOBILE DEVICE SYNCHRONIZATION OF SCREEN CONTENT AND AUDIO is hereby incorporated herein by reference in its entirety.

Systems and methods are disclosed for providing synchronized visible and/or audible content for play on a plurality of mobile devices located within a venue. The disclosed systems and methods can provide, to each of the plurality of mobile devices, a piece of the visible and/or audible content that is mapped to a specific location of the mobile device within the venue, and trigger the respective mobile devices to play their pieces of the visible and/or audible content in a synchronous fashion, thereby creating a display of the visible and/or audible content in which each mobile device effectively corresponds to either a picture element (or “pixel”) or a sound source, or both, within the display.

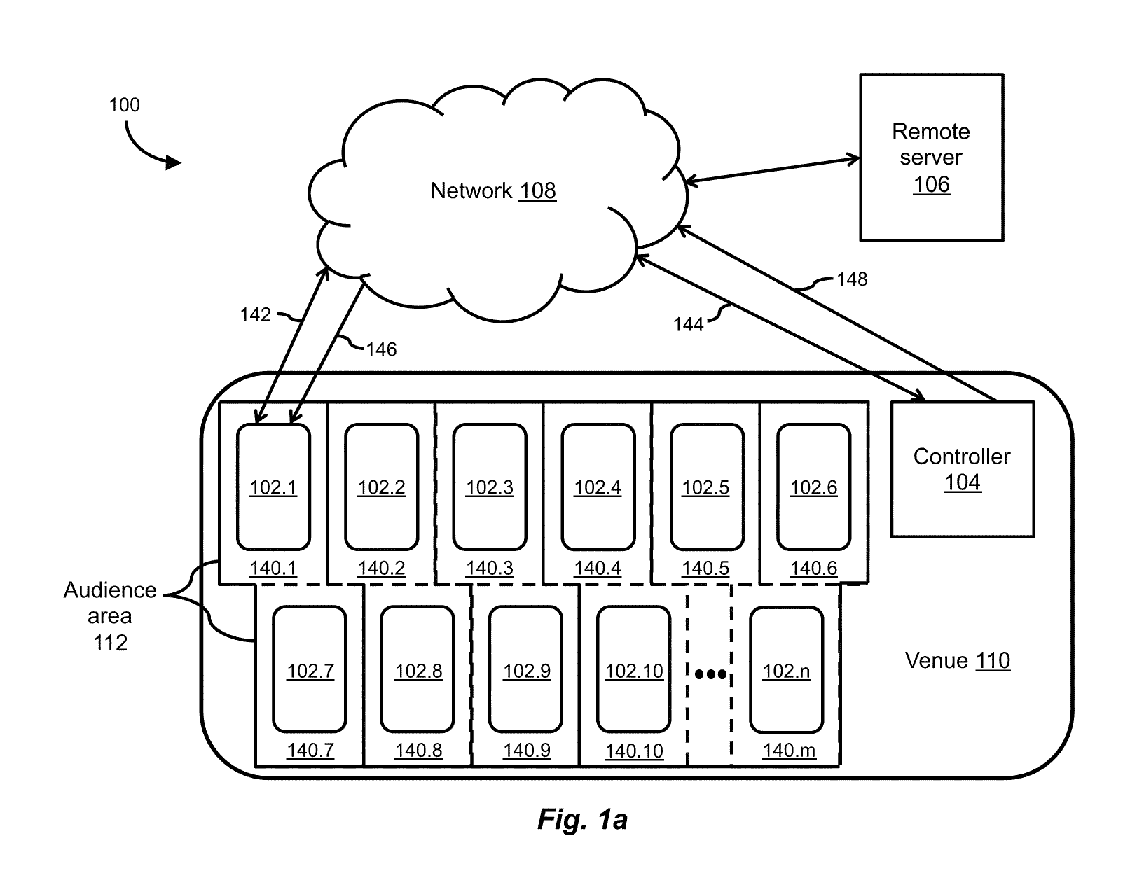

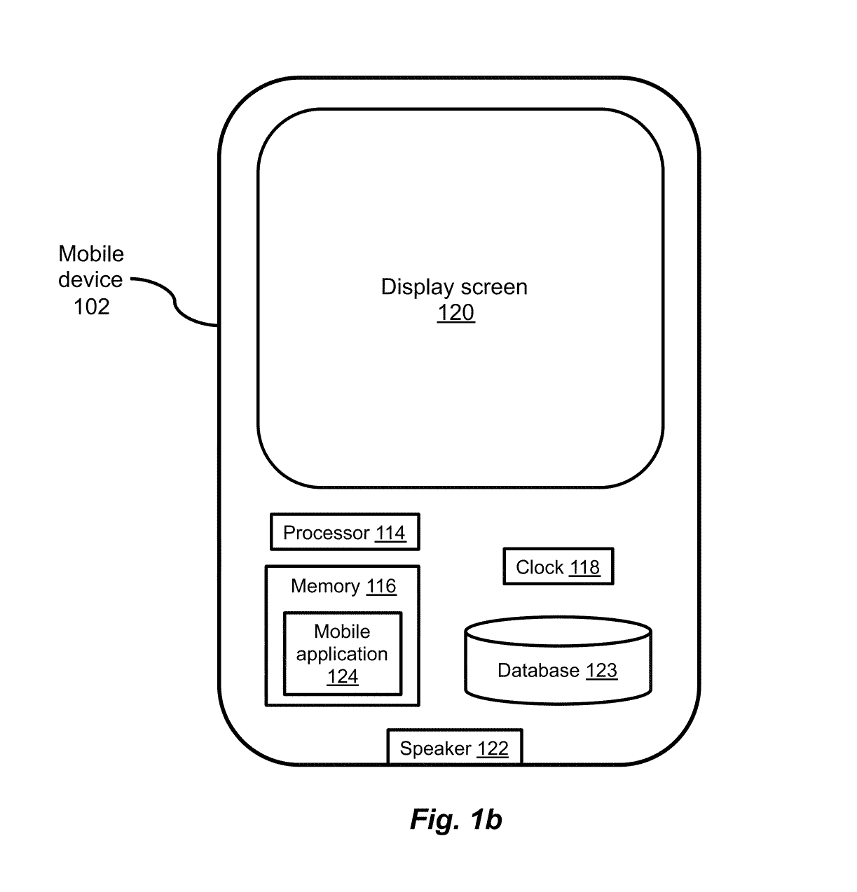

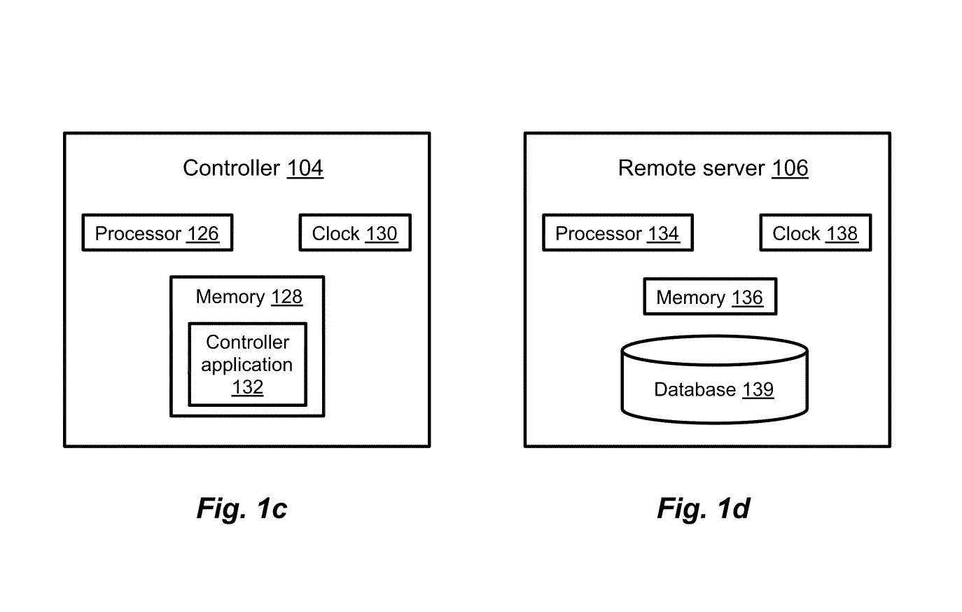

FIG. 1a depicts an illustrative embodiment of a system 100 for providing synchronized visible and/or audible content for play on a plurality of mobile devices 102.1-102.n located within a venue 110, in accordance with the present application. As shown in FIG. 1a, the system 100 includes the plurality of mobile devices 102.1-102.n, a computerized controller (or “controller”) 104, and at least one remote server computer (or “remote server”) 106, which is communicably coupleable to each of the plurality of mobile devices 102.1-102.n and the controller 104 over at least one network 108. For example, each mobile device 102.1, 102.2, . . . , 102.n can be a smartphone, a tablet computer (or “tablet”), or any other suitable computerized mobile device. Further, the network 108 can be the Internet and/or any other suitable wired and/or wireless communications network.

As shown in FIG. 1b with reference to an exemplary one of the plurality of mobile devices 102.1-102.n (such an exemplary mobile device being referred to in FIG. 1b by the reference numeral 102), each mobile device 102.1, 102.2, . . . , 102.n includes a processor 114, a memory 116, an internal clock 118, a display screen 120, a speaker 122, and a content database 123. The processor 114 within the mobile device 102 is operative to execute a mobile application program (or “mobile application”) 124 out of the mobile device's memory 116 for implementing specified functionality of the mobile device 102 within the system 100. As shown in FIG. 1c, the controller 104 includes a processor 126, a memory 128, and an internal clock 130. The processor 126 within the controller 104 is operative to execute a controller application program (or “controller application”) 132 out of the controller's memory 128 for implementing specified functionality of the controller 104 within the system 100. As shown in FIG. 1d, the remote server 106 likewise includes a processor 134, a memory 136, an internal clock 138, and a content database 139.

In an exemplary mode of operation, the system 100 can be employed in the venue 110 (see FIG. 1a) such as a concert hall, a sports stadium or arena, a playing field, or any other suitable venue that typically attracts a large number (e.g., hundreds, thousands) of audience members. Preferably, each (or at least a majority) of the audience members has a mobile device such as the mobile device 102 (e.g., a smartphone, a tablet) in his or her possession at the venue, and is situated with the mobile device 102 at a specific location in an audience area 112 of the venue 110. With regard to this exemplary mode of operation, the audience area 112 is divided into a plurality of sub-areas 140.1-140.m, and the specific location of each mobile device 102.1, 102.2, . . . , 102.n within the venue 110 corresponds to one of the plurality of sub-areas 140.1, 140.2, . . . , 140.m of the audience area 112. As shown in FIG. 1a, for example, the specific location of the mobile device 102.1 can correspond to the sub-area 140.1, the specific location of the mobile device 102.2 can correspond to the sub-area 140.2, the specific location of the mobile device 102.3 can correspond to the sub-area 140.3, the specific location of the mobile device 102.4 can correspond to the sub-area 140.4, the specific location of the mobile device 102.5 can correspond to the sub-area 140.5, and so on up to the specific location of the mobile device 102.n corresponding to the sub-area 140.m. In this exemplary mode of operation, the audience area 112 is divided into a number, m, of sub-areas 140.1-140.m that is greater than the number, n, of mobile devices 102.1-102.n (i.e., m>n) within the venue 110, and, therefore, there can be at least one sub-area 140.11, 140.12, . . . , 140.m-1 (not shown) that does not correspond to the specific location of any one of the plurality of mobile devices 102.1-102.n within the venue 110. It is noted, however, that the audience area 112 can be divided into a number, m, of sub-areas that is greater than (i.e., m>n), less than (i.e., m<n), or equal to (i.e., m=n) the number, n, of mobile devices 102.1-102.n within the venue 110.

With further regard to this exemplary mode of operation, each mobile device 102.1, 102.2, . . . , 102.n has a copy of the mobile application 124 downloaded onto it. For example, each audience member may download a copy of the mobile application 124 over the Internet (or any other suitable communications network) into the memory 116 of his or her mobile device 102 while at the venue 110, or prior to arriving at the venue 110. Having downloaded the copy of the mobile application 124 onto his or her mobile device 102, each audience member can open the mobile application 124 on the mobile device 102 while at the venue 110, allowing the processor 114 within the mobile device 102 to execute the mobile application 124 out of the mobile device's memory 116.

In this exemplary mode of operation, the mobile application 124 running on each mobile device 102.1, 102.2, . . . , 102.n can perform the following operations in order to prepare the mobile device 102 for playing synchronized visible and/or audible content substantially in unison with the other mobile devices 102.1, 102.2, . . . , and/or 102.n within the venue 110. For example, the visible and/or audible content can correspond to a static or dynamic image (e.g., a sports team banner), a static or dynamic pattern (e.g., a sweeping wave pattern), a series of audio and/or light tracks, an array of hexadecimal color values, and/or any other suitable visible and/or audible content that can be played by the respective mobile devices 102.1-102.n.

First, the mobile application 124 running on the mobile device 102 establishes, over the network 108, a secure connection with the remote server 106 in order to enable full duplex, real-time communications between the mobile device 102 and the remote server 106 over the network 108. In one embodiment, the mobile application 124 establishes the secure connection with the remote server 106 as a secure transmission control protocol (TCP) connection by sending a WebSocket handshake request to the remote server 106 over the network 108. The remote server 106 accepts the WebSocket handshake request from the mobile device 102, and returns a WebSocket handshake response to the mobile device 102 over the network 108, thereby opening a real-time communication (RTC) pipe corresponding to the secure TCP connection between the mobile device 102 and the remote server 106. For example, the WebSocket handshake response returned by the remote server 106 can be a WebSocket message that includes a serialized JavaScript object notation (JSON) object for confirming the secure TCP connection with the mobile device 102.

It is noted that such a JSON object returned by the remote server 106 to confirm the secure TCP connection with the mobile device 102 can be serialized/de-serialized by both the remote server 106 and the mobile application 124 running on the mobile device 102, thereby facilitating the passing of messages, data, and/or values between the mobile device 102 and the remote server 106 using the JSON key value structure. Such a JSON object that conforms to the JSON key value structure can be expressed as follows:

{“e”: “s:c_e”, “d”: { } }, (1)

in which “e” is a key expressed as an abbreviation of the term “event,” “s:c_e” is a value corresponding to the key “e” expressed as an abbreviation of the term “socket: connection established,” and “d” is a key expressed as an abbreviation of the term “data.” Because the purpose of this JSON object (see expression (1)) is simply to confirm the establishment of the secure TCP connection between the mobile device 102 and the remote server 106, the JSON object does not contain any data and/or values, as indicated by the empty brackets “{ }” (see expression (1)) following the key “d.”

Next, the mobile application 124 running on the mobile device 102 communicates with the remote server 106 over the secure connection to synchronize the internal clock 118 of the mobile device 102 with the internal clock 138 of the remote server 106, producing a positive or negative offset value that the mobile application 124 can add to a time value of the mobile device's internal clock 118 in order to simulate the time of the remote server's internal clock 138. In one embodiment, the mobile application 124 synchronizes the internal clock 118 of the mobile device 102 with the internal clock 138 of the remote server 106 by sending a plurality of ping messages to the remote server 106 over the network 108 at regular timed intervals, e.g., every 2,000 milliseconds, or any other suitable time interval. The sending of such ping messages by the mobile devices 102.1-102.n to the remote server 106 is illustrated in FIG. 1a with reference to the mobile device 102.1 by a bidirectional communications path 142 between the mobile device 102.1 and the network 108. It is noted, however, that such a bidirectional communications path for sending ping messages is also employed between each of the mobile devices 102.2, 102.3, . . . , 102.n and the network 108. Only the bidirectional communications path 142 between the mobile device 102.1 and the network 108 is shown in FIG. 1a for clarity of illustration.

Upon the sending of a ping message at each regular timed interval, the mobile application 124 obtains the current time, ct¹ (in milliseconds), of the mobile device's internal clock 118, and stores the current time, ct¹, in the mobile device's memory 116, in timestamp format, in an array along with an identifying key for the timestamp. Such an identifying key (“Key”; see expression (2)) and timestamp (“Timestamp”; see expression (2)) for the current time, ct¹, of the mobile device's internal clock 118 can be expressed as follows:

Key: 42, Timestamp: 1403532313000, (2)

in which “42” is an exemplary key value for the current time, ct¹, of the internal clock 118, and “1403532313000” is an exemplary timestamp value for the current time, ct¹, of the internal clock 118. In expression (2), the exemplary key value “42” corresponds to the 42^{nd} regular time interval for sending the ping messages to the remote server 106, and the exemplary timestamp “1403532313000” corresponds to the current time, ct¹, of the internal clock 118 at the 42^{nd} regular time interval, as expressed in Unix time.

Having stored the timestamp (“Timestamp”; see expression (2)) in the array along with the identifying key (“Key”; see expression (2)) in the memory 116 of the mobile device 102, the mobile application 124 sends, to the remote server 106 over the secure connection through the network 108, a serialized WebSocket message containing the key value (e.g., “42”; see expression (2)) that corresponds to the stored timestamp value (e.g., “1403532313000”; see expression (2)). Such a serialized WebSocket message (i.e., a JSON object) sent by the mobile application 124 to the remote server 106 can be expressed, as follows:

{e: “p”, d: {i: 42} }, (3)

in which “p” corresponds to the event “ping,” and “i: 42” corresponds to the data contained in the JSON object (“i” being a key expressed as an abbreviation of the term “identifier,” and “42” corresponding to the stored key value for the timestamp value, “1403532313000”; see expression (2)).

Upon receiving the serialized WebSocket message containing the identifying key corresponding to the current time, ct¹, of the mobile device's internal clock 118, the remote server 106 sends, to the mobile device 102, a serialized WebSocket message containing the current time, st¹ (in milliseconds), of its internal clock 138 in timestamp format, along with the value of the identifying key (e.g., “42”; see expression (3)) provided in the serialized WebSocket message received from the mobile device 102. Such a serialized WebSocket message (i.e., a JSON object) sent by the remote server 106 can be expressed, as follows:

{e: “p”, d:{i: 42, t: 1403532313422} }, (4)

in which “i: 42, t: 1403532313422” corresponds to the data contained in the JSON object (“t” being a key expressed as an abbreviation of the term “timestamp,” and “1403532313422” corresponding to an exemplary timestamp value for the current time, st¹, of the remote server's internal clock 138).

Upon receiving the serialized WebSocket message containing the identifying key corresponding to the current time, ct¹, of the mobile device's internal clock 118, as well as the timestamp value for the current time, st¹, of the remote server's internal clock 138, the mobile application 124 again obtains the current time, ct² (in milliseconds), of the mobile device's internal clock 118, and subtracts the previously obtained current time, ct¹ (corresponding to the value, 42, of the identifying key returned by the remote server 106 in the serialized WebSocket message; see expression (4)) from the newly obtained current time, ct², thereby obtaining the round trip time, RTT, required for sending a serialized WebSocket message to the remote server 106, and receiving a serialized WebSocket message in return from the remote server 106. The mobile application 124 then divides the round trip time, RTT, by “2” in order to obtain an approximate transport time for sending a single WebSocket message from the mobile device 102 over the secure connection through the network 108 to the remote server 106, as follows:

SMTT=(ct²−ct¹)/2, (5)

in which “SMTT” corresponds to the approximate single message transport time, “ct²” corresponds to the newly obtained current time of the mobile device's internal clock 118, and “ct¹” corresponds to the previously obtained current time of the mobile device's internal clock 118. Replacing the newly and previously obtained current times, “ct²” and “ct¹,” in equation (5) with their corresponding exemplary timestamp values, 1403532313370 and 1403532313000, respectively, the approximate single message transport time, SMTT, can be obtained, as follows:

SMTT=(1403532313370-1403532313000)/2, (6a)

SMTT=(370)/2, and (6b)

SMTT=185 (in milliseconds). (6c)

Having obtained the approximate single message transport time, SMTT, corresponding to the 42^{nd} regular time interval for sending the ping messages to the remote server 106, the mobile application 124 stores the SMTT value (e.g., “185 (in milliseconds)”; see equation (6c)) in the mobile device's memory 116 in the array alongside the value of the identifying key (i.e., 42) for the 42^{nd} regular time interval. In one embodiment, the array implemented within the memory 116 of the mobile device 102 can store up to 20 or more such SMTT values, which can subsequently be employed by the mobile application 124 to monitor the average single message transport time from the mobile device 102 to the remote server 106.

In the event the approximate single message transport time, SMTT, obtained in equation (6c) is the first SMTT value obtained by the mobile application 124, the mobile application 124 stores the SMTT value (i.e., “185 (in milliseconds)”; see equation (6c)) in the array within the mobile device's memory 116 as the lowest SMTT value. If the approximate single message transport time, SMTT, obtained in equation (6c) is not the first SMTT value obtained by the mobile application 124, but is less than the lowest SMTT value currently stored in the array, then the mobile application 124 replaces the lowest SMTT value currently in the array with the SMTT value obtained in equation (6c), and calculates (or re-calculates) the positive or negative offset value that the mobile application 124 can add to the time value of the mobile device's internal clock 118 in order to simulate the time of the remote server's internal clock 138. Alternatively, if the approximate single message transport time, SMTT, obtained in equation (6c) is not the first SMTT value obtained by the mobile application 124, but is greater than the lowest SMTT value currently stored in the array, then the mobile application 124 increases the lowest SMTT value currently stored in the array by 1 millisecond (or any other suitable time value), and does not calculate (or re-calculate) the positive or negative offset value used by the mobile application 124 to simulate the time of the remote server's internal clock 138.

In this exemplary mode of operation, the mobile application 124 calculates (or re-calculates) the positive or negative offset value (“Offset”; see equation (7)) that it can use to simulate the time of the remote server's internal clock 138, as follows:

Offset=st¹+SMTT−ct² (7)

in which “st¹” corresponds to the current time, in milliseconds, of the remote server's internal clock 138, which was returned by the remote server 106 in response to a corresponding ping message sent by the mobile application 124; “SMTT” corresponds to the approximate single message transport time, as calculated in accordance with equation (5); and, “ct²” corresponds to the current time, in milliseconds, of the mobile device's internal clock 118. It is noted that the mobile application 124 can calculate the offset value (“Offset”; see equation (7)) if the SMTT value is the first SMTT value obtained by the mobile application 124, or re-calculate the offset value (“Offset”; see equation (7)) if the mobile application 124 determines that the SMTT value is less than the lowest SMTT value currently stored in the array within the mobile device's memory 116. Replacing the current time, st¹, of the remote server's internal clock 138, the approximate single message transport time, SMTT, and the current time, ct², of the mobile device's internal clock 118, as in equation (7), with their corresponding values from expression (4), equation (6c), and equation (6a), respectively, the mobile application 124 can calculate the offset value, Offset, as follows:

Offset=1403532313422+185−1403532313370, and (8a)

Offset=237 milliseconds. (8b)

It is noted that the calculation of the offset value, Offset, in equation (8b) might result in a negative value if, for example, the remote server's internal clock 138 were running behind the mobile device's internal clock 118. The mobile application 124 can add the positive or negative offset value, Offset, obtained in accordance with equation (7) to the current time of the mobile device's internal clock 118 in order to simulate, as desired and/or required, the time of the remote server's internal clock 138.

The mobile application 124 running on the mobile device 102 then subscribes to a specific channel of the remote server 106, allowing the remote server 106 to publish, over the subscribed channel, one or more trigger messages to the respective mobile devices 102.1, 102.2, . . . , 102.n. For example, in response to one or more directives from the controller 104, the remote server 106 can publish such a trigger message(s) over the subscribed channel to direct the mobile application 124 running on some or all of the respective mobile devices 102.1, 102.2, . . . , 102.n to play pieces of the visible and/or audible content in a synchronous fashion. In one embodiment, the mobile application 124 subscribes to the specific channel of the remote server 106 by sending, to the remote server 106, a serialized WebSocket message (i.e., a JSON object) that can be expressed as follows:

{e: “s:s”, d: {c: “exampleChannel”, “id”: “2857-C5B3-0794-5K9S”} }, (9)

in which “s:s” is a value corresponding to the key “e” expressed as an abbreviation of the term “subscription succeeded,” and “c: ‘exampleChannel’, ‘id’: ‘2857-C5B3-0794-5K9S’” corresponds to the data contained in the JSON object (“c” being a key expressed as an abbreviation of the term “channel,” “exampleChannel” corresponding to the key value of the specific channel to which the mobile application 124 is subscribing, “id” being a key expressed as an abbreviation of the term “identifier,” and “2857-C5B3-0794-5K9S” corresponding to the key value of a unique identifier of the mobile device 102).

Having received the WebSocket message (see expression (9)) from the mobile application 124 for subscribing the mobile device 102 to the specific channel of the remote server 106, the remote server 106 accepts the WebSocket message, and subscribes the mobile device 102 to an event driven publish/subscribe service, such as the Redis publish/subscribe service, or any other suitable publish/subscribe service. Once each of the plurality of mobile devices 102.1, 102.2, . . . , 102.n has been subscribed to the specific channel of the remote server 106, the remote server 106 can publish, in response to one or more directives from the controller 104, one or more trigger messages to all of the respective mobile devices 102.1-102.n over the subscribed channel. Having accepted the WebSocket message (see expression (9)) from the mobile application 124, the remote server 106 returns a serialized WebSocket message to the mobile application 124 to confirm the mobile device's subscription. Such a serialized WebSocket message (i.e., a JSON object) returned by the remote server 106 can be expressed as follows:

{e: “s_i:s_s”, c: “exampleChannel”, d: {} }, (10)

in which “s_i:s_s” is a value corresponding to the key “e” expressed as an abbreviation of the term “subscription information: subscription succeeded.”

The mobile application 124 running within the mobile device 102 can then determine the specific location (e.g., latitude, longitude, or localized coordinates) of the mobile device 124 in the audience area 112 of the venue 110 using global positioning system (GPS) technology, Bluetooth beacon technology, or any other suitable location/position determination technology, and send an indication of the determined location of the mobile device 102 in the audience area 112 of the venue 110, along with an event identifier, to the remote server 106 over the secure connection through the network 108. Alternatively, the specific location (e.g., section number, seat number) of the mobile device 124 in the audience area 112 of the venue 110 can be entered manually into the mobile device 102 by the audience member, and subsequently sent along with the event identifier to the remote server 106. For example, the mobile application 124 can send the indication of the determined location of the mobile device 102 to the remote server 106 as data of a POST request in a serialized WebSocket message (i.e., a JSON object), which can be expressed as follows:

{e: “loc”, c: “exampleChannel”, d: { “lat”: 18.92038860, “lng”: 72.83013059999999 }}, (11)

in which “loc” is a value corresponding to the key “e” expressed as an abbreviation of the term “location,” and “'1at': 18.92038860, ‘1ng’: 72.83013059999999” corresponds to the data contained in the JSON object (“lat” being a key value expressed as an abbreviation of the term “latitude,” and “1ng” being a key value expressed as an abbreviation of the term “longitude”).

Having received the POST request with the data indicating the specific location of the mobile device 102 in the audience area 112 of the venue 110, the remote server 106 searches its content database 139 for the event identifier to find a source content file (e.g., a JSON file) pertaining to a piece of visible and/or audible content to be played by the mobile device 102 at that specific location in the audience area 112. For example, the remote server 106 (or any other suitable server or computerized device) can, prior to the performance or event being held at the venue 110, map pieces of the visible and/or audible content to the plurality of sub-areas 140.1, 140.2, . . . , 140.m of the audience area 112 by running any suitable server application program that can generate a plurality of smaller content files from a single, larger source content file (e.g., by dividing the source content file into a plurality of subdivided content files). The remote server 106 then sends, to the mobile device 102, a copy of a subdivided content file (PNG file(s), WAV file(s)) containing the piece of the visible and/or audible content to be played by the mobile device 102 at that specific location in the audience area 112. The mobile application 124 stores the piece of visible and/or audible content, in its entirety, in the mobile device's content database 123. In one embodiment, the mobile application 124 can store the piece of visible and/or audible content in the mobile device's content database 123 in an array format, an abbreviated example of which follows:

{

“exagig00”: {

“id”: “exagig00”,
“images”: [
[

“www.example.com/exagig00/t0f0.png”,
“www.example.com/exagig00/t0f1.png”,
“www.example.com/exagig00/t0f2.png”,
“www.example.com/exagig00/t0f45.png”,

]
],
“audio”: [

“www.example.com/exagig00/0.wav”,
“www.example.com/exagig00/1.wav”,
“www.example.com/exagig00/2.wav”,
“www.example.com/exagig00/12.wav”,

],
“content”: [

[

[

“99FF33”,
1,
0

],
[

“FF66FF”,
3,
0

],

]

]

}

},

in which “exagig00” corresponds to an event identifier, “images” corresponds to visible content contained in a plurality of portable network graphics (PNG) files, “audio” corresponds to audible content contained in a plurality of waveform audio (WAV) files, and “content” corresponds to optional additional content that can be used to supplement the visible content and audible content contained in the PNG files and WAV files, respectively.

In one embodiment, the mobile application 124 can search the copy of the JSON file stored in the content database 123 for keys corresponding to optional additional image and/or audio content that the mobile application 124 can download over the network 108 to further supplement the visible and/or audible content contained in the JSON file. For example, if such additional image and/or audio content are available for downloading by the mobile application 124, then the mobile application 124 can employ one or more uniform resource locators (URLs) supplied in the JSON file to locate and download the additional image and/or audio content. Further, the mobile application 124 can store such additional image and/or audio content in the content database 123 along with the visible and/or audible content contained in the JSON file.

Once the mobile application 124 running on the mobile device 102 has prepared the respective mobile device for playing, in the audience area 112 of the venue 110, its stored piece of the visible and/or audible content, substantially in unison with the other mobile devices 102.1, 102.2, . . . , and/or 102.n playing their stored pieces of the visible and/or audible content, the mobile application 124 can wait to receive one or more trigger messages from the remote server 106 over the subscribed channel.

In this exemplary mode of operation, the processor 126 within the controller 104 can execute the controller application 132 out of the memory 128 of the controller 104 to perform the following operations in order to prepare the controller 104 to send one or more directives to the remote server 106. First, the controller application 132 running on the controller 104 establishes, over the network 108, a secure connection between the controller 104 and the remote server 106, enabling full duplex, real-time communications between the controller 104 and the remote server 106 over the secure connection through the network 108. For example, the controller application 132 can establish such a secure connection with the remote server 106 by sending a WebSocket handshake request to the remote server 106 over the network 108, and receiving a WebSocket handshake response from the remote server 106 in response to the WebSocket handshake request.

Next, the controller application 132 running on the controller 104 communicates with the remote server 106 in order to synchronize the internal clock 130 of the controller 104 with the internal clock 138 of the remote server 106, producing a positive or negative offset value that the controller application 132 can add to a time value of the controller's internal clock 130 in order to simulate the time of the remote server's internal clock 138. In one embodiment, the controller application 132 synchronizes the internal clock 130 of the controller 104 with the internal clock 138 of the remote server 106 by sending a plurality of ping messages to the remote server 106 over the network 108 at regular timed intervals, e.g., every 2,000 milliseconds, or any other suitable time interval, as described herein with reference to the synchronization of the mobile device's internal clock 118 with the remote server's internal clock 138. The sending of such ping messages by the controller 104 to the remote server 106 is illustrated in FIG. 1a by a bidirectional communications path 144 between the controller 104 and the network 108.

The controller application 132 running on the controller 104 can then send, at a selected time(s) during a musical performance, a sporting event, or any other suitable performance or event being held at the venue 110, at least one directive to the remote server 106 over a communications path 148 between the controller 104 and the network 108, causing the remote server 106 to publish, over the subscribed channel, at least one trigger message to the mobile application 124 running on each of the respective mobile devices 102.1-102.n within the venue 110. The sending of such a trigger message by the remote server 106 to the mobile devices 102.1-102.n is illustrated in FIG. 1a with reference to the mobile device 102.1 by a communications path 146 between the mobile device 102.1 and the network 108. It is noted, however, that such a communications path for receiving a trigger message(s) is also employed between each of the mobile devices 102.2, 102.3, . . . , 102.n and the network 108. Only the communications path 146 between the mobile device 102.1 and the network 108 is shown in FIG. 1a for clarity of illustration.

Such a trigger message can take the form of a serialized WebSocket message (i.e., a JSON object), which can be expressed as follows:

{e: “m”, c: “exampleChannel”, d:{t: 6, st: 1403600223000} }, (12)

in which “m” is a value corresponding to the key “e” expressed as an abbreviation of the term “message,” and “t: 6, st: 1403600223000” corresponds to the data contained in the JSON object (“t” being a key expressed as an abbreviation of the term “track,” “6” corresponding to the key value of the specific track of the stored content to be played, “st” being a key expressed as an abbreviation of the term “start,” and “1403600223000” corresponding to the key value, in timestamp format, of the time within the stored content where the playing of the stored content is to start).

It is noted that the key value of the time within the stored visible and/or audible content where the playing of the stored content is meant to start (e.g., “1403600223000”; see expression (12)) can be set at a time in the future or in the past. If this key value of the time is set in the past, then the mobile application 124 can obtain the simulated time of the remote server's internal clock 138, compare the simulated time of the remote server's internal clock 138 to the time indicated by the key value, and cause the mobile device 102 to start playing its stored piece of visible and/or audible content at a later time within the stored content corresponding to the difference between the simulated time of the remote server's internal clock 138 and the time indicated by the key value. In this way, no matter what time a trigger message is received from the remote server 106 over the subscribed channel at the plurality of mobile devices 102.1-102.n, the respective mobile devices 102.1-102.n can be assured to play their stored pieces of the visible and/or audible content substantially in unison at the appropriate times within the stored content.

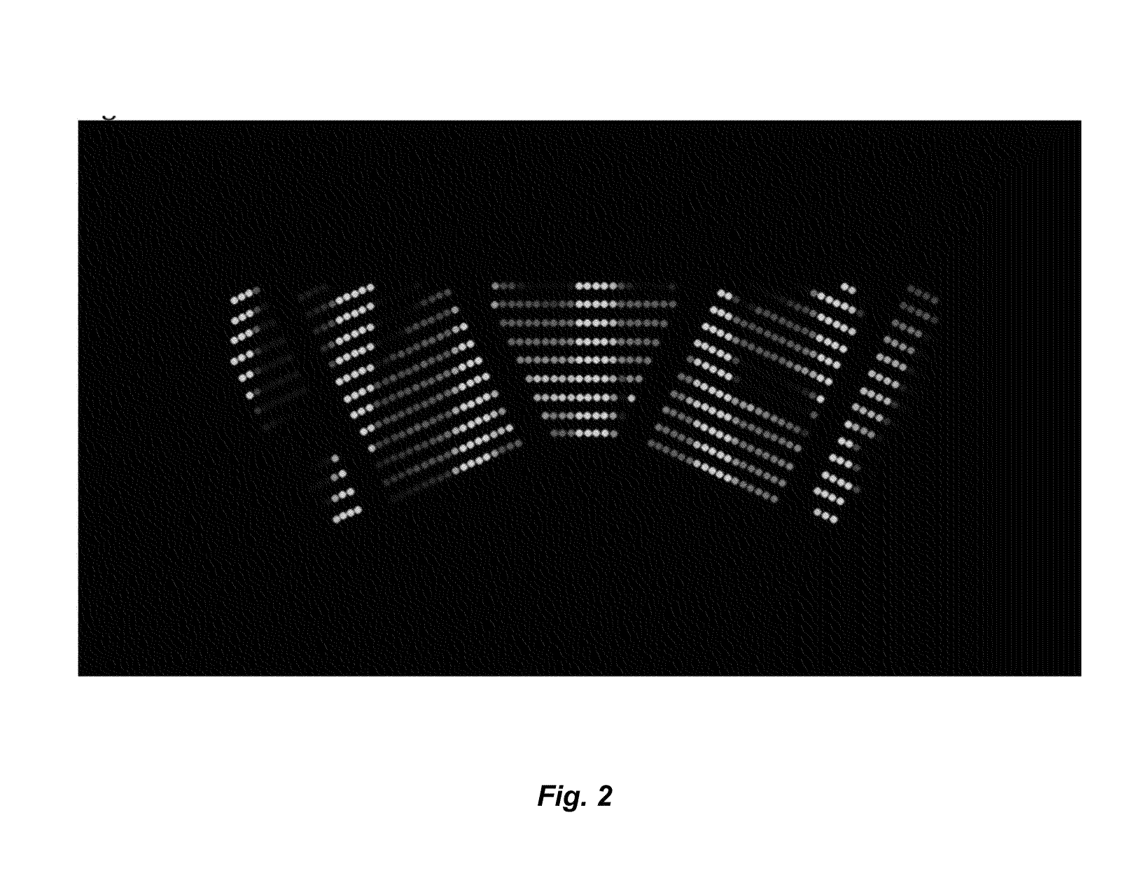

Having received the trigger message(s) from the remote server 106, the mobile application 124 running on the respective mobile devices 102.1-102.n play, in a synchronous fashion, their stored pieces of the visible and/or audible content on the display screen 120 and/or the speaker 122 of each of the respective mobile devices 102.1-102.n, thereby creating a display of the visible and/or audible content that can encompass substantially the whole audience area 112 of the venue 110. FIG. 2 depicts a representation of an exemplary display of the visible and/or audible content played on the plurality of mobile devices 102.1-102.n, in which each mobile device 102.1, 102.2, . . . , 102.n effectively corresponds to either a pixel or a sound source, or both, within the display.

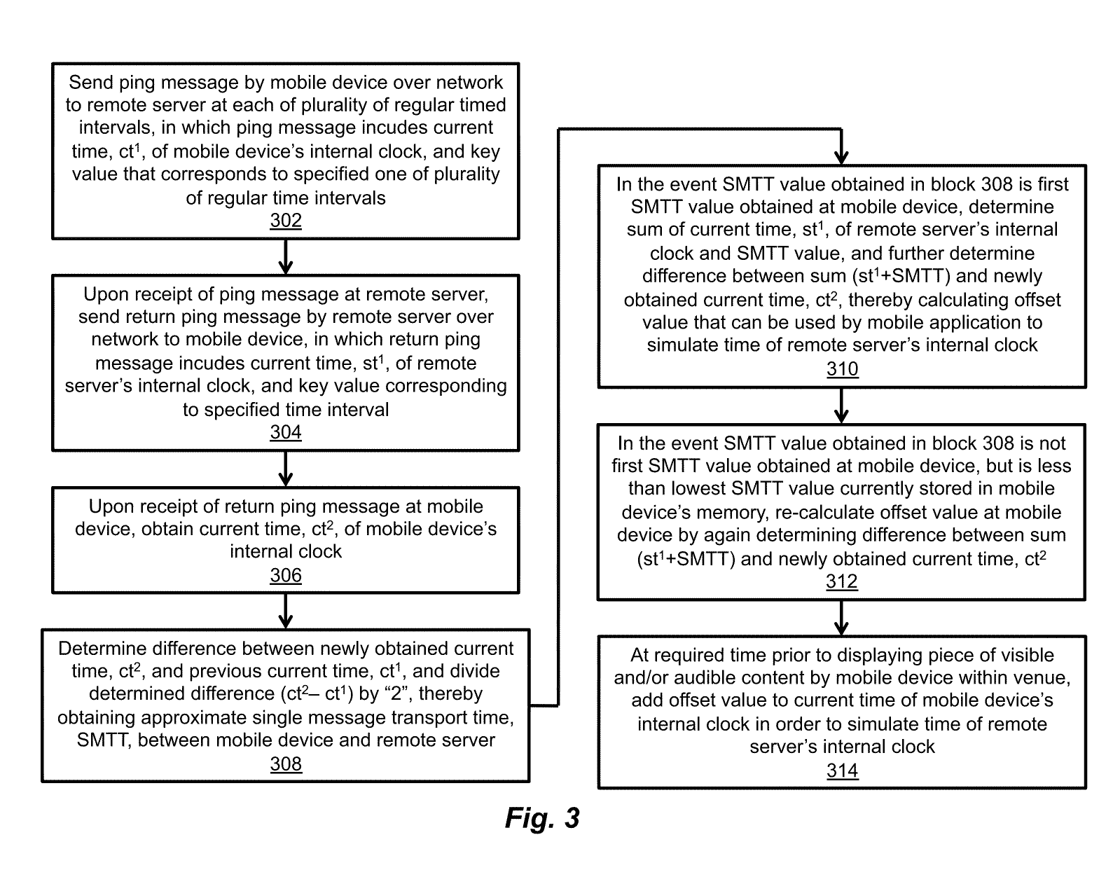

An exemplary method of synchronizing the internal clock 118 of the mobile device 102 with the internal clock 138 of the remote server 106 is described below with reference to FIGS. 1a-1d and 3. As depicted in block 302 (see FIG. 3), a ping message is sent by the mobile device 102 over the network 108 to the remote server 106 at each of a plurality of regular timed intervals, in which the ping message incudes the current time, ct¹, of the internal clock 118, and a key value that corresponds to a specified one of the plurality of regular time intervals. As depicted in block 304, upon receipt of the ping message at the remote server 106, a return ping message is sent by the remote server 106 over the network 108 to the mobile device 102, in which the return ping message incudes the current time, st¹, of the internal clock 138 of the remote server 106, and the key value corresponding to the specified one of the regular time intervals. As depicted in block 306, upon receipt of the return ping message at the mobile device 102, the current time, ct², of the internal clock 118 is obtained at the mobile device 102. As depicted in block 308, the difference between the newly obtained current time, ct², and the previous current time, ct¹, is determined at the mobile device 102, and the determined difference (ct²-ct¹) is divided by “2” at the mobile device 102, thereby obtaining the approximate single message transport time, SMTT, between the mobile device 102 and the remote server 106. As depicted in block 310, in the event the SMTT value obtained in block 308 is the first SMTT value obtained at the mobile device 102, the sum of the current time, st¹, of the internal clock 138 of the remote server 106 and the SMTT value is determined at the mobile device 102, and the difference between the sum (st¹+SMTT) and the newly obtained current time, ct², is further determined at the mobile device 102, thereby calculating an offset value that can be used by the mobile application 124 to simulate the time of the remote server's internal clock 138. As depicted in block 312, in the event the SMTT value obtained in block 308 is not the first SMTT value obtained at the mobile device 102, but is less than the lowest SMTT value currently stored in the mobile device's memory 116, the offset value is re-calculated at the mobile device 102 by again determining the difference between the sum, st¹+SMTT, and the newly obtained current time, ct². As depicted in block 314, at a required time prior to displaying a piece of visible and/or audible content by the mobile device 102 within the venue 110, the offset value is added to the current time of the mobile device's internal clock 118 in order to simulate the time of the remote server's internal clock 138.

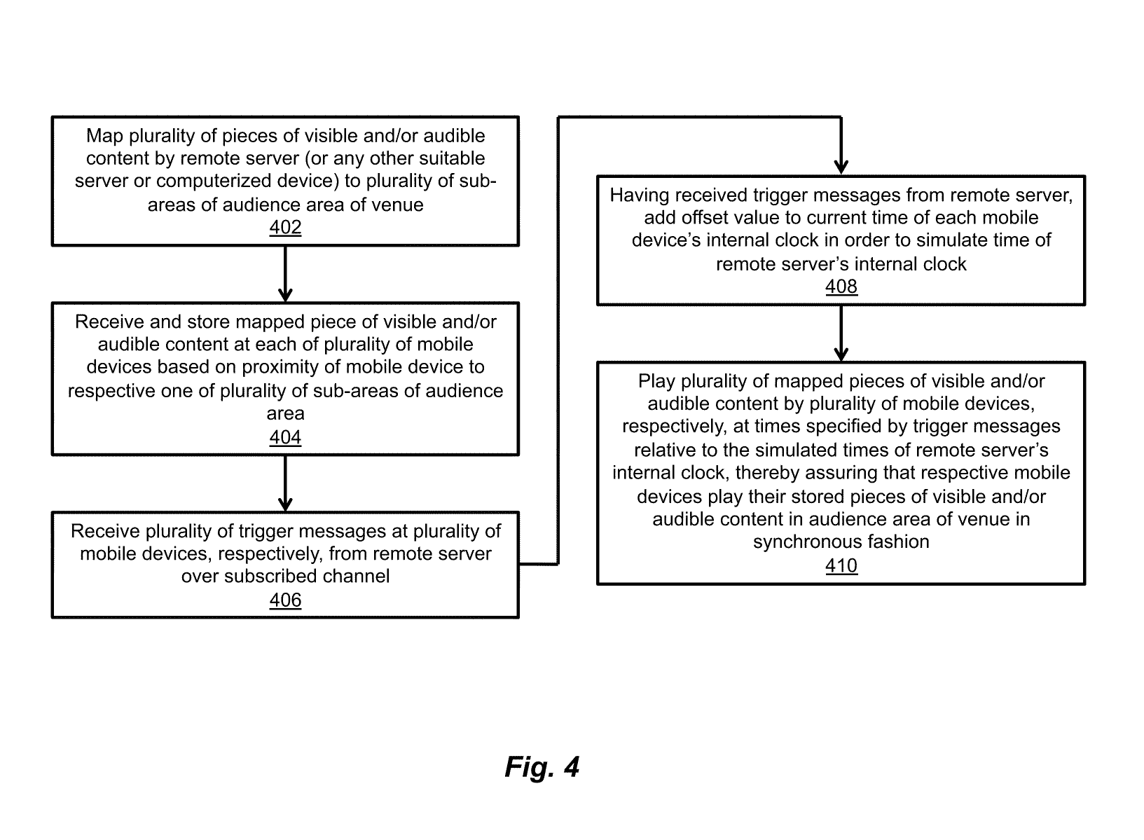

An exemplary method of providing synchronized visible and/or audible content for play on the plurality of mobile devices 102.1-102.n located in the audience area 112 of the venue 110 is described below with reference to FIGS. 1a-1d and 4. As depicted in block 402 (see FIG. 4), a plurality of pieces of visible and/or audible content are mapped, by the remote server 106 (or any other suitable server or computerized device), to the plurality of sub-areas 140.1-140.m of the audience area 112 of the venue 110. As depicted in block 404, a mapped piece of the visible and/or audible content is received and stored at each of the plurality of mobile devices 102.1-102.n based on the proximity of the mobile device 102 to a respective one of the plurality of sub-areas 140.1-140.m of the audience area 112. As depicted in block 406, a plurality of trigger messages are received at the plurality of mobile devices 102.1-102.n, respectively, from the remote server 106 over a subscribed channel. As depicted in block 408, having received the trigger messages from the remote server 106, an offset value is added to the current time of each mobile device's internal clock 118 in order to simulate the time of the remote server's internal clock 138. As depicted in block 410, the plurality of mapped pieces of visible and/or audible content are played by the plurality of mobile devices 102.1-102.n, respectively, at times within the mapped content specified by the trigger messages relative to the simulated times of the internal clock 138, thereby assuring that the respective mobile devices 102.1-102.n play their stored pieces of visible and/or audible content in the audience area 112 of the venue 110 in a synchronous fashion.

Having described the above illustrative embodiments, other variations of and/or modifications to the above-described illustrative embodiments can be made and/or practiced.

For example, it was described herein that, while the mobile application 124 running on the mobile device 102 subscribes to a specific channel of the remote server 106, the remote server 106 can confirm the mobile device's subscription by returning a serialized WebSocket message to the mobile application 124, in which the serialized WebSocket message (i.e., a JSON object) can include a key value “s_i:s_s” (subscription information: subscription succeeded) corresponding to the key “e” (event), a key value “exampleChannel” corresponding to the key “c” (channel), and empty brackets “{ }” corresponding to the key “d” (data), signifying that the returned serialized WebSocket message contains no data. In an alternative embodiment, the returned serialized WebSocket message can include data within the empty brackets corresponding to the key “d,” in which the data can include a key value corresponding to the key “t” that indicates the specific track of stored content to be played by the mobile device 102, as well as a key value corresponding to the key “st” that indicates the time within the stored content where the playing of the stored content is to start. In this way, once the mobile device 102 has successfully subscribed to the specific channel of the remote server 106, the mobile device 102 can be triggered to start playing its stored content within the venue 110 almost immediately, in the case where the other mobile devices 102.1, 102.2, . . . , and/or 102.n within the venue 110 have already started to play their stored content.

It was also described herein that, having received a trigger message(s) from the remote server 106, the mobile application 124 running on the respective mobile devices 102.1-102.n can play, in a synchronous fashion, their stored pieces of the visible and/or audible content on the display screen 120 and/or the speaker 122 of each mobile device 102.1, 102.2, . . . , or 102.n, thereby creating a display of the visible and/or audible content that can encompass substantially the whole audience area 112 of the venue 110. In an alternative embodiment, each mobile device 102.1, 102.2, . . . , 102.n can further include at least one light emitting diode (LED), which can be activated in conjunction with the display screen 120 to play the stored pieces of visible content, thereby enhancing the visual effect of the displayed visible content.

It is noted that the operations described herein are purely exemplary and imply no particular order. Further, the operations can be used in any sequence when appropriate and can be partially used. With the above illustrative embodiments in mind, it should be understood that the above-described systems and methods could employ various computer-implemented operations involving data transferred or stored in computer systems. These operations are those requiring physical manipulation of physical quantities. Usually, though not necessarily, these quantities take the form of electrical, magnetic, or optical signals capable of being stored, transferred, combined, compared, and/or otherwise manipulated.

Moreover, any of the operations described herein that form part of the above-described systems and methods are useful machine operations. The above-described systems and methods also relate to a device or an apparatus for performing such operations. The apparatus can be specially constructed for the required purpose, or the apparatus can be a general-purpose computer selectively activated or configured by a software program stored in the computer. In particular, various general-purpose machines employing one or more processors coupled to one or more computer readable media can be used with software programs written in accordance with the teachings herein, or it may be more convenient to construct a more specialized apparatus to perform the required operations.

The above-described systems and methods can also be embodied as computer readable code on a computer readable medium. The computer readable medium is any data storage device that can store data, which can be thereafter be read by a computer system.

Examples of such computer readable media include hard drives, read-only memory (ROM), random-access memory (RAM), CD-ROMs, CD-Rs, CD-RWs, magnetic tapes, and other optical and non-optical data storage devices. The computer readable media can also be distributed over a network-coupled computer system so that the computer readable code is stored and executed in a distributed fashion.

It will be appreciated by those of ordinary skill in the art that modifications to and variations of the above-described systems and methods may be made without departing from the inventive concepts disclosed herein. Accordingly, the invention should not be viewed as limited except as by the scope and spirit of the appended claims.

What is claimed is:

1. A method of providing synchronized content for play on a plurality of mobile devices located within a venue, the plurality of mobile devices being communicably coupleable to a remote server over at least one network, comprising:
obtaining, by the remote server, the content for play at the venue, the content including one or more of visible content and audible content, the venue including an audience area, the audience area including a plurality of sub-areas, the remote server having an internal clock;
mapping a plurality of pieces of the content to the plurality of sub-areas in the audience area, at least some of the plurality of mobile devices being located in a proximity of at least some of the plurality of sub-areas in the audience area, each of the plurality of mobile devices having an internal clock;
receiving, at each mobile device from the remote server, a mapped piece of the content based on the proximity of the mobile device to a respective sub-area in the audience area;
synchronizing, by each mobile device, the internal clock of the mobile device to the internal clock of the remote server;
receiving, at each mobile device, at least one trigger message from the remote server, the trigger message containing a specific time in the mapped piece of content where playing of the mapped piece of content by the mobile device is to start; and
playing, by each mobile device, the mapped piece of content starting at the specific time relative to the synchronized internal clock of the mobile device.

2. The method of claim 1 wherein the synchronizing of the internal clock of each mobile device to the internal clock of the remote server includes producing a positive or negative offset value, and adding the offset value to a predetermined time value of the internal clock of the mobile device.

3. The method of claim 2 wherein the synchronizing of the internal clock of each mobile device to the internal clock of the remote server further includes sending, by each mobile device, a plurality of ping messages to the remote server over the network at regular timed intervals, each ping message including a first key value corresponding to a first device time value, the first device time value representing a first device time of the internal clock of the mobile device.

4. The method of claim 3 wherein the synchronizing of the internal clock of each mobile device to the internal clock of the remote server further includes receiving, at each mobile device from the remote server, a return ping message for each of at least some of the plurality of ping messages sent by the mobile device, the return ping message including the first key value corresponding to the first device time value, and a first server time value (st¹) representing a first server time of the internal clock of the remote server.

5. The method of claim 4 wherein the synchronizing of the internal clock of each mobile device to the internal clock of the remote server further includes, upon receiving the return ping message from the remote server, obtaining, by each mobile device, a second device time value representing a second device time of the internal clock of the mobile device, and calculating an approximate single message transport time (SMTT) from the mobile device to the remote server over the network based on the first device time value (ct¹) and the second device time value (ct²).

6. The method of claim 5 wherein the synchronizing of the internal clock of each mobile device to the internal clock of the remote server further includes producing the positive or negative offset value by calculating the offset value (Offset) in accordance with the equation, Offset=st¹+SMTT−ct².

7. The method of claim 6 wherein the synchronizing of the internal clock of each mobile device to the internal clock of the remote server further includes adding the Offset to the predetermined time value of the internal clock of the mobile device.

8. The method of claim 1 further comprising:
establishing, by each mobile device, a secure connection to the remote server over the network, the secure connection enabling full duplex, real-time communications between the mobile device and the remote server over the network.

9. The method of claim 1 further comprising:
subscribing, by each mobile device, to a channel of the remote server.

10. The method of claim 9 wherein the subscribing to the channel of the remote server includes receiving, at each mobile device, a confirmation message confirming the subscribing of the mobile device to the channel of the remote server, the confirmation message containing the specific time in the mapped piece of content where playing of the mapped piece of content by the mobile device is to start.

11. The method of claim 10 wherein the receiving of the trigger message from the remote server includes receiving the trigger message over the subscribed channel.

12. The method of claim 1 further comprising:
synchronizing, by a controller, an internal clock of the controller to the internal clock of the remote server, the controller being communicably coupleable to the remote server over the network.

13. The method of claim 12 further comprising:
sending, by the controller, at least one directive to the remote server to send the trigger message to the respective mobile devices.

14. The method of claim 1 wherein the obtaining of the content for play at the venue includes obtaining a source content file containing the content for play at the venue.

15. The method of claim 14 wherein the mapping of the plurality of pieces of the content to the plurality of sub-areas in the audience area includes dividing the source content file into a plurality of subdivided content files, each subdivided content file including a respective piece of content, and mapping the plurality of subdivided content files to the plurality of sub-areas in the audience area.

16. A system for providing synchronized content over at least one network for play on a plurality of mobile devices within a venue, each mobile device including an internal device clock, comprising:
a remote server including a server processor, a server memory, and an internal server clock; and
a controller including a controller processor and a controller memory, the controller being communicably coupleable to the remote server over the network,
wherein the server processor is operative to execute at least one computer program out of the server memory:
to obtain the content for play at the venue, the content including one or more of visible content and audible content, the venue including an audience area, the audience area including a plurality of sub-areas;
to map a plurality of pieces of the content to the plurality of sub-areas in the audience area, at least some of the plurality of mobile devices being located in a proximity of at least some of the plurality of sub-areas in the audience area, each of the plurality of mobile devices having an internal device clock synchronized to the internal server clock; and
to send, to each mobile device over the network, a mapped piece of the content based on the proximity of the mobile device to a respective sub-area in the audience area,
wherein the controller processor is operative to execute at least one controller application program out of the controller memory to send at least one directive to the remote server, and
wherein the server processor is further operative to execute the at least one computer program out of the server memory to send, in response to the directive from the controller, a trigger message to the respective mobile devices, the trigger message containing a specific time in the mapped piece of content, relative to the synchronized internal device clock, where playing of the mapped piece of content by a respective mobile device is to start.

17. The system of claim 16 wherein the controller further includes an internal controller clock, and wherein the controller processor is further operative to execute the at least one controller application program out of the controller memory to synchronize the internal controller clock to the internal server clock.

18. A computer readable medium having computer readable code thereon that, while being executed by a processor, performs a method of providing synchronized content for play on one of a plurality of mobile devices located within a venue, each mobile device having an internal device clock, the method comprising:
establishing a secure connection to a remote server over at least one network, the secure connection enabling full duplex, real-time communications between a mobile device and the remote server over the network, the remote server having an internal server clock;
subscribing to a channel of the remote server;
synchronizing the internal device clock to the internal server clock;
receiving, from the remote server, a mapped piece of the content based on a proximity of the mobile device to a respective sub-area in an audience area of the venue;
receiving at least one trigger message from the remote server, the trigger message containing a specific time in the mapped piece of content where playing of the mapped piece of content by the mobile device is to start; and
playing the mapped piece of content starting at the specific time relative to the synchronized internal device clock.

19. The computer readable medium of claim 18 wherein the method further comprises:
producing a positive or negative offset value; and
adding the offset value to a predetermined time value of the internal device clock to synchronize the internal device clock to the internal server clock.

20. The computer readable medium of claim 18 wherein the method further comprises:
sending a plurality of ping messages to the remote server over the network at regular timed intervals, each ping message including a key value corresponding to a device time value, the device time value representing a device time of the internal device clock; and
receiving from the remote server, a return ping message for each of at least some of the plurality of ping messages, the return ping message including the key value corresponding to the device time value.
